(19) United States
(12) Patent Application Publication
(10) Pub. No.: US 2025/0333936 A1
(43) Pub. Date: Oct. 30, 2025

(54) FAUCET UNDERBODY WITH ONE-PIECE MANIFOLD

(71) Applicant: AS America, Inc., Piscataway, NJ (US)

(72) Inventors: Xiaojing YE, Edison, NJ (US); David ESPIRITO SANTO, Colonia, NJ (US); Weijian ZHANG, Guangzhou (CN); Changqing LI, Guangzhou (CN)

(73) Assignee: AS America, Inc., Piscataway, NJ (US)

(21) Appl. No.: 19/176,490

(22) Filed: Apr. 11, 2025

(30) Foreign Application Priority Data
Apr. 28, 2024 (WO) PCT/CN2024/090371

(51) Int. Cl. E03C 1/04; F16K 11/00

(52) U.S. Cl. CPC E03C 1/0401; F16K 19/006

(57) ABSTRACT

A faucet underbody comprises a one-piece manifold, which comprises: a spout opening comprising a first side and a second side, a first side valve on the first side of the spout opening and a second side valve on the second side of the spout opening, wherein the first and second side valves each comprise a valve housing, and a bridge integrally connecting the first and second side valves on the first and second sides of the spout opening. The faucet underbody further comprises two valve cartridges, each comprising one or more O-rings, a stationary ceramic disc, a moveable ceramic disc, a stem, and a friction washer; and two male-threaded cartridge nuts, wherein the male-threaded cartridge nuts are configured to engage with female-threaded surfaces of each of the valve housings of the first and second side valves.

### CROSS-REFERENCE TO RELATED APPLICATIONS

This application claims the priority of International Patent Application No. PCT/CN2024/090371, filed Apr. 28, 2024, the entire contents of which are incorporated herein by reference.

### FIELD

This disclosure relates generally to faucets, and more specifically to faucet manifolds, faucet valves, and faucet valve cartridges.

### BACKGROUND

Component parts of faucets are typically manufactured as separate pieces which must later be assembled. Additionally, many of these parts, such as cartridge nuts, are typically made of expensive materials such as brass, due to requirements and limitations of current designs. The high number of separately manufactured parts in known faucet designs, and the limited use of cost-effective materials in known faucet designs, make the manufacturing and assembly of faucet parts expensive and complex.

### SUMMARY

As noted above, known faucet designs rely on a high number of separately manufactured parts and rely on expensive materials, making manufacture and assembly expensive and complex. Accordingly, there is a need for a faucet underbody that can be manufactured with fewer pieces and more cost-effective materials without sacrificing functionality. The faucet underbodies described herein meet this need by providing a manifold manufactured as a single piece, by obviating the need for cartridge housings, and/or by providing male-threaded cartridge nuts that can create an improved seal and can be made from cost-effective materials such as plastic. By providing a faucet underbody with a one-piece manifold and male-threaded cartridge nuts described herein, the manufacture and assembly of faucets can be simplified and made less expensive, allowing for improved faucet designs, improved manufacturing reliability, and improved efficiencies.

In some embodiments, a faucet underbody is provided, the faucet underbody comprising a one-piece manifold. In some embodiments, the one-piece manifold comprises: a spout opening comprising a first side and a second side, a first side valve on the first side of the spout opening and a second side valve on the second side of the spout opening, wherein the first and second side valves each comprise a valve housing, and a bridge integrally connecting the first and second side valves on the first and second sides of the spout opening. In some embodiments, the faucet underbody comprises two valve cartridges, each comprising one or more O-rings, a stationary ceramic disc, a moveable ceramic disc, a stem, and a friction washer; and two male-threaded cartridge nuts, wherein the male-threaded cartridge nuts are configured to engage with female-threaded surfaces of each of the valve housings of the first and second side valves to secure the valve cartridges within the first and second side valves.

In some embodiments, the male-threaded cartridge nuts are made of plastic.

In some embodiments, the one-piece manifold is made of plastic.

In some embodiments, the one-piece manifold is made of a plastic comprising one or more of a polyamide, a polyester, a polycarbonate, an acrylonitrile-butadiene-styrene, a polysulfone (PSU), a polyethersulfone (PESU), a cyclic olefin copolymer (COC), a polyphenylenesulfone (PPSU), a polyether ether ketone (PEEK), a polyethylenimine (PEI), a polyphthalamide (PPA), a polyacetal, copolymers thereof, or blends thereof.

In some embodiments, the plastic comprises Grivory HT1V-5 FWA natural.

In some embodiments, the male-threaded cartridge nuts and the female-threaded surfaces have a thread size of at least one of M22 by 1.5 or 13/16-16UN-3B.

In some embodiments, each valve housing of the first and second side valves is configured to receive and directly interface with each valve cartridge.

In some embodiments, each valve cartridge is configured to be fully assembled when received by each valve housing of the first and second side valves.

In some embodiments, each valve cartridge is configured to be assembled within each valve housing by consecutively fitting together parts of each valve cartridge inside each valve housing of the first and second side valves.

In some embodiments, each valve cartridge comprises two or more integrated handle stop ribs.

In some embodiments, each valve housing comprises two or more handle stops spaced apart on a first side and a second side of a circular interior surface of each valve housing, wherein each valve housing is configured to receive each respective integrated handle stop rib between each respective handle stop.

In some embodiments, each respective integrated handle stop rib is configured to engage with each respective handle stop upon rotation of the respective valve cartridge within the first or second side valve so as to restrict rotation of a respective faucet handle attached to the respective valve cartridge.

In some embodiments, the integrated handle stop ribs and the handle stops are configured to restrict rotation of the respective faucet handle to a quarter turn.

In some embodiments, the faucet underbody is configured to be installed underneath a centerset faucet.

In some embodiments, the faucet underbody is configured to be installed underneath a widespread faucet.

In some embodiments, a method of manufacturing a faucet underbody is provided, the method comprising: molding a one-piece manifold from plastic, the one-piece manifold comprising: a spout opening comprising a first side and a second side, a first side valve on the first side of the spout opening and a second side valve on the second side of the spout opening, wherein the first and second side valves each comprise a valve housing, and a bridge integrally connecting the first and second side valves on the first and second sides of the spout opening. In some embodiments, the method comprises assembling valve cartridges by fitting valve cartridge parts consecutively into the first and second side valves; and securing the valve cartridges inside the first and second side valves by securing male-threaded cartridge nuts to female-threaded surfaces of the valve housings of the first and second side valves.

In some embodiments, the one-piece manifold is molded from plastic comprising one or more of a polyamide, a polyester, a polycarbonate, an acrylonitrile-butadiene-styrene, a polysulfone (PSU), a polyethersulfone (PESU), a cyclic olefin copolymer (COC), a polyphenylenesulfone (PPSU), a polyether ether ketone (PEEK), a polyethylenimine (PEI), a polyphthalamide (PPA), a polyacetal, copolymers thereof, or blends thereof.

In some embodiments, the one-piece manifold is molded from plastic comprising Grivory HT1V-5 FWA natural.

In some embodiments, any one or more of the features or aspects of any of the embodiments recited above may be combined in whole or in part with one another, and/or may be combined in whole or in part with any other feature or aspect disclosed herein.

### BRIEF DESCRIPTION OF THE FIGURES

The invention will now be described, by way of example only, with reference to the accompanying drawings, in which:

FIG. 1A illustrates a faucet underbody, in accordance with some embodiments herein.

FIG. 1B illustrates an exploded view of a faucet underbody, in accordance with some embodiments herein.

FIG. 2 illustrates a faucet underbody, in accordance with some embodiments herein.

FIG. 3 illustrates an exploded view of a valve cartridge, in accordance with some embodiments herein.

FIG. 4A illustrates a faucet underbody attached to a faucet, in accordance with some embodiments herein.

FIG. 4B illustrates a faucet underbody attached to a faucet, in accordance with some embodiments herein.

In the Figures, like reference numbers refer to like components unless stated herein to the contrary.

### DETAILED DESCRIPTION

Described herein are faucet underbodies having a one-piece manifold that can be manufactured in fewer parts than conventional faucet underbodies. The one-piece manifold may include a spout opening with two side valves on either side of the spout opening, and a bridge integrally connecting the two side valves into a single piece. The side valves may include a valve housing, which may have a female-threaded surface, and a shank. As described herein, the faucet underbodies may also include two valve cartridges and two male-threaded cartridge nuts. The valve cartridges may include one or more O-rings, a stationary ceramic disc, a moveable ceramic disc, a stem, and a friction washer. The male-threaded cartridge nuts may be configured to attach to a female-threaded surface of each of the valve housings of the side valves to secure the valve cartridges within the side valves. The one-piece manifold and/or the male-threaded cartridge nuts may be made of plastic.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

The above description is presented to enable a person skilled in the art to make and use the disclosure and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein.

As used throughout the description and figures, faucet underbody 100, 200, 400 is used to label and describe the entire assembly comprising the valve cartridges, cartridge nuts, and one-piece manifold, while the one-piece manifold 102, 202 is used to label and describe the side valves/bridge piece that are separate from and house the valve cartridges and cartridge nuts.

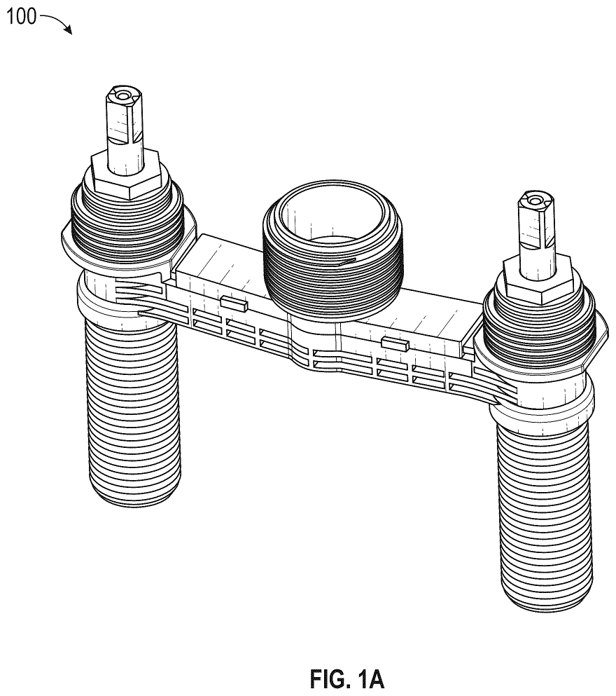

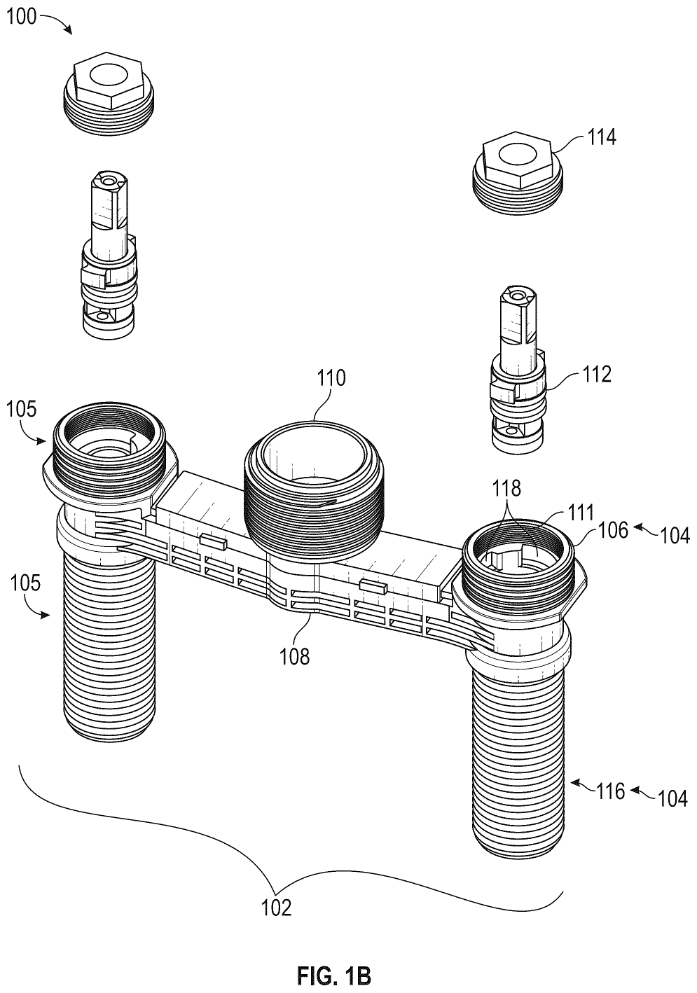

FIGS. 1A and 1B depict a faucet underbody, in accordance with some embodiments herein. FIG. 1A illustrates a perspective view of faucet underbody 100, while FIG. 1B illustrates an exploded view of faucet underbody 100 highlighting various component parts of the faucet underbody. Referring to FIG. 1B, faucet underbody 100 may include a one-piece manifold 102. The one-piece manifold 102 may have a spout opening 110 and two side valves 104, 105 on either side of the spout opening. In some embodiments, a first side valve 104 may be a cold water valve, while a second side valve 105 may be a hot water valve, or vice versa. One-piece manifold 102 may also have a bridge 108 integrally connecting side valves 104 and 105 on either side of the spout opening so as to form a single piece.

In some embodiments, the one-piece manifold 102 may be made of a cost-effective material, such as plastic. In some embodiments, the plastic may be any thermoplastic, for example any engineering thermoplastic, for example polyamides, polyesters, polycarbonates, acrylonitrile-butadiene-styrene, polysulfones (PSU), polyethersulfones (PESU), cyclic olefin copolymer (COC), polyphenylenesulfones (PPSU), polyether ether ketones (PEEK), polyethylenimine (PEI), polyphthalamides (PPA), polyacetals, copolymers thereof, or blends thereof. For example, a thermoplastic may include a glass-filled polyamide or a glass-filled polyphthalamide. Additionally, a thermoplastic may include Grivory HT1V-5 FWA natural, which is a 50% glass fibre reinforced engineering thermoplastic material based on a semi-crystalline, partially aromatic copolyamide. In some embodiments, the one-piece manifold may be molded and manufactured as a single piece via injection molding or other plastic molding processes suitable for manufacturing integrated parts.

Still referring to FIG. 1B, faucet underbody 100 may also include two valve cartridges 112 and two male-threaded cartridge nuts 114. The side valves 104, 105 may each include a valve housing 106 and a shank 116. Each valve housing 106 may have a female-threaded surface 111, for example, above handle stops 118. The side valves 104, 105 may be configured to receive the valve cartridges 112. Valve cartridges 112 may be secured within the side valves 104, 105 when the male-threaded cartridge nuts 114 engage with the female-threaded surfaces 111 of each valve housing 106.

Because male threads can be made thicker and can be fitted within the valve housings 106 of the side valves 104, this allows male-threaded cartridge nuts 114 to be made of a more cost-effective material, such as plastic. By contrast, if the cartridge nuts had female threading, they may require a more expensive material such as brass. For example, female-threaded cartridge nuts require a greater wall thickness in order to enhance strength and withstand burst pressure tests. However, the thicker wall on a female-threaded cartridge nut does not work well in a plastic injection molding process and can lead to voids and shrinkage in the molded product. In addition to cost-effectiveness, plastic male threads can form a tighter seal when compared to plastic female threads. The plastic male thread is capable of enduring a greater pretension load compared to the female thread, which helps ensure that the cartridge nut remains secure and does not loosen throughout the lifespan of the faucet.

In some embodiments, the male-threaded cartridge nuts may be made of plastic. In some embodiments, the plastic may be any thermoplastic, for example any engineering thermoplastic, for example polyamides, polyesters, polycarbonates, acrylonitrile-butadiene-styrene, polysulfones (PSU), polyethersulfones (PESU), cyclic olefin copolymer (COC), polyphenylenesulfones (PPSU), polyether ether ketones (PEEK), polyethylenimine (PEI), polyphthalamides (PPA), polyacetals, copolymers thereof, or blends thereof. For example, a thermoplastic may include a glass-filled polyamide or a glass-filled polyphthalamide. Additionally, a thermoplastic may include Grivory HT1V-5 FWA natural, which is a 50% glass fibre reinforced engineering thermoplastic material based on a semi-crystalline, partially aromatic copolyamide. In some embodiments, the male-threaded cartridge nuts 114 and the female-threaded surfaces 111 may have a thread size of M22 by 1.5. In some embodiments, the male-threaded cartridge nuts 114 and the female-threaded surfaces 111 may have a thread size of 13/16-16UN-3B. In some embodiments, any other thread sizes suitable for a faucet handle may be used.

Additionally, valve cartridges 112 may include handle stop ribs 338, which may engage with the handle stops 118 within the side valves 104, 105 to restrict rotation of a faucet handle. In some embodiments, each valve housing 106 of the side valves 104, 105 includes two or more handle stops 118 integrated within valve housings 106, such that the handle stops are molded as a single piece with the valve housings 106. As shown in FIG. 1B, handle stops 118 may be spaced apart on a first side and a second side of a circular interior surface of each valve housing, shown on the inside of side valves 104, 105 below female-threaded surface 111. The valve housings 106 integrated within side valves 104, 105 are configured to receive each respective integrated handle stop rib between each respective handle stop.

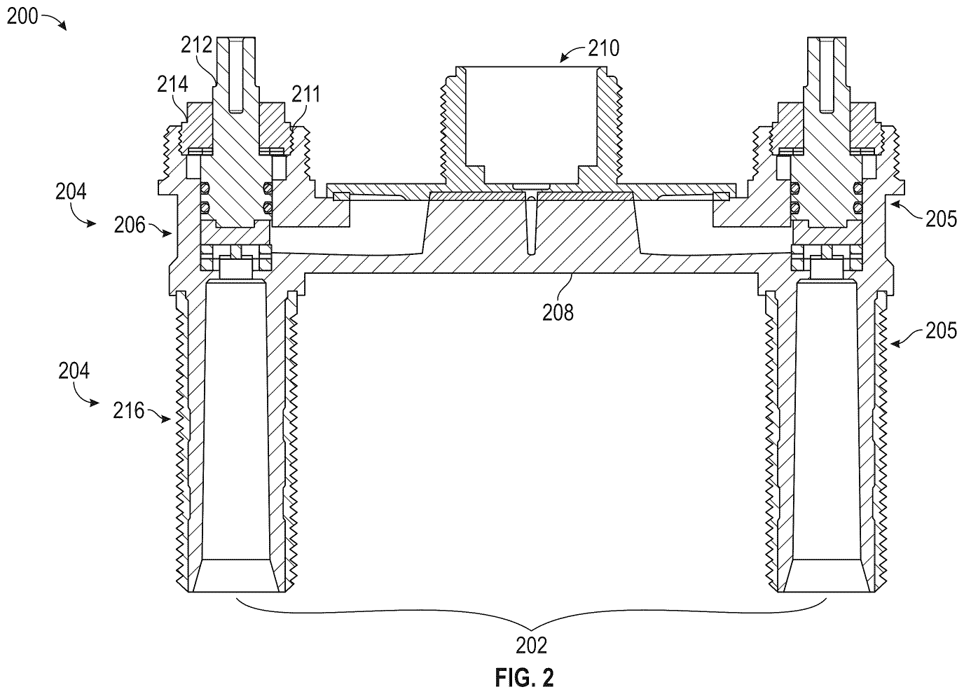

In some embodiments, valve housings 106 can also be shaped to receive and interface directly with the valve cartridge 112, thereby obviating the need for a separate valve housing piece such that a valve cartridge 112 may be placed directly within valve housing 106. For example, the structure of the inside of the valve housings 106 may mirror or closely resemble the structure of the corresponding valve cartridge 212, as will be described with respect to FIG. 2. In some embodiments, not including several separate valve housing pieces in faucet underbody 100 may reduce the number of parts required during manufacturing, thus simplifying manufacture and assembly of faucet parts.

For example, FIG. 2 illustrates an internal view of faucet underbody 200, in accordance with some embodiments herein. The inside of the side valves 204, 205 may have built-in, or integrated valve housings 206 configured to house valve cartridges 212 within side valves 204, 205 instead of requiring an additional piece within the side valves 204, 205. The valve housings 206 mirror and/or closely resemble the structure of the corresponding valve cartridge 212. In this way, one-piece manifold 202 can be thought of as including an “integrated valve housing” or a “built-in” valve housing, in that components shaped to serve functions of a valve housing may be formed integrally within one-piece manifold 202. In some embodiments, valve cartridge 212 can be fully assembled when fitted inside valve housing 206 within side valves 204, 205 during manufacturing. In some embodiments, valve cartridge 212 can be assembled by consecutively fitting the individual parts of the valve cartridge 212 into valve housing 206 and then securing the parts together.

Regarding the remaining components shown in FIG. 2, some or all of the components of one-piece manifold 202 shown in FIG. 2 can be the same as those shown in FIG. 1, such as spout opening 210 and bridge 208 integrally connecting side valves 204, 205. Each side valve 204, 205 may have a valve housing 206 and a shank 216. Shank 216 is threaded and can connect to a water supply line (not shown). Shank 216 may be made from a metal material such as brass or aluminum and may be bonded to the one-piece manifold 202 via an insert molding process. As additionally shown in FIG. 2, male-threaded cartridge nuts 214 can engage with female-threaded surfaces 211 of the valve housings 206 to secure valve cartridges 212 within the side valves 204. In some embodiments, the male-threaded cartridge nuts 214 are the only piece required to secure valve cartridges 212 within the side valves 204, further reducing the number of parts required in the faucet underbody 200.

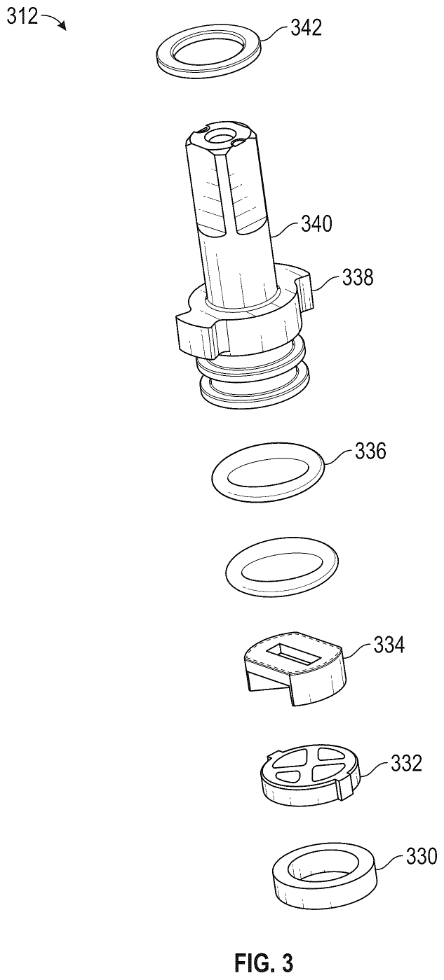

Referring to FIG. 3, FIG. 3 depicts an exploded view of valve cartridge 312, showing various components thereof. The valve cartridge 312 may include a seal 330, a stationary ceramic disk 332, a moveable ceramic disc 334, and one or more O-rings 336. Valve cartridge 312 can also include a stem 340 and a friction washer 342. As shown in FIGS. 1B and 2, stem 340 of valve cartridge 112, 212 protrudes from valve housings 106, 206 of side valves 104, 204 through the center of the male-threaded cartridge nut 114, 214. Friction washer 342 is secured between the base of stem 340 and the male-threaded cartridge nut 114, 214 to prevent leaks. Stem 340 can then be attached to a handle of a faucet.

As shown in FIG. 3, valve cartridge 312 may include handle stop ribs 338 that may be integrated to form a single piece with the stem 340 of the valve cartridge 312, unlike conventional valve cartridges. As described earlier with respect to FIG. 1B, the valve housing 106 of each side valve 104, 105 can be configured to receive the handle stop ribs 338 of valve cartridge 112, 212, 312 such that the handle stop ribs 338 are received in gaps between handle stops 118 in valve housing 106. When a user of a faucet turns a faucet handle, the valve cartridge 112 rotates within the gap between handle stops 118 until the handle stop ribs 338 engage with the handle stops 118. In some embodiments, the handle stops 118 and handle stop ribs 338 are spaced apart such that rotation of the valve cartridge 112, and therefore the faucet handle, is restricted to a quarter turn, or approximately 90 degrees. Handle stops 118 may be configured to restrict the rotation of valve cartridge 112 in either a clockwise or counterclockwise direction, depending on whether the valve cartridge is to be used for hot or cold water and whether it will be attached to the left or right handle of the faucet.

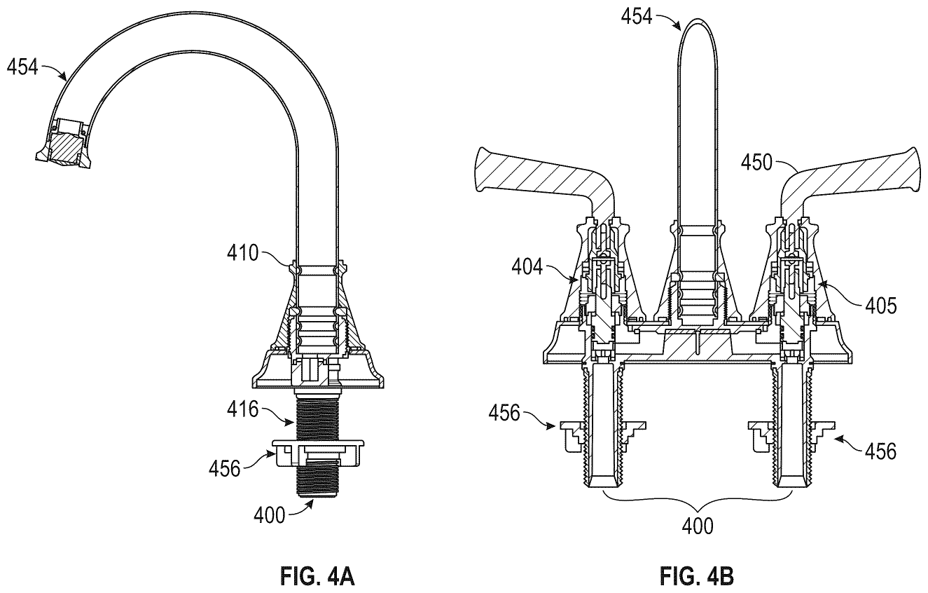

FIGS. 4A and 4B illustrate faucet underbody 400 attached underneath a faucet, with pipes omitted for a clearer view. In some embodiments, faucet underbody 400 may be configured to fit a centerset faucet, which may measure approximately four inches across from the center of a first side valve to a center of a second side valve. In some embodiments, faucet underbody 400 may be configured to fit a widespread faucet, which may measure approximately eight inches across from the center of a first side valve to a center of a second side valve.

FIG. 4A shows the faucet underbody 400 from a side view of the spout 454, which is received through spout opening 410 of the one-piece manifold. Male threads on the outside of the spout opening 410 can engage with female threads on the inside of the spout 454 from underneath a countertop. Mounting nuts 456 secure the faucet underbody 400 to an underside of the countertop. The shank 416 is externally threaded for attachment to a water line underneath the countertop.

Turning to FIG. 4B, stems on the valve cartridges of the first and second side valves 404, 405 can attach to faucet handles 450 from underneath a countertop, while male threads on the outside of the side valves 404, 405 can engage with female threads within the faucet handles. The threading on the outside of the side valves 404, 405 is shown, for example, in FIG. 1B. A further benefit of making faucet underbody 400 primarily from a lightweight plastic material is that additional structural support does not need to be provided by an escutcheon of the faucet. This allows the escutcheon to also be made of a cost-effective material, such as plastic, further reducing manufacturing costs. Otherwise, if the escutcheon was needed for structural support for the faucet underbody 400, the escutcheon would need to be made of a heavier, more expensive material such as zinc. Instead, the escutcheon can be purely decorative and can lay on a surface of the countertop below handles 450 and above the bridge of the one-piece manifold. Support is provided by the engagement of the male threads on the outside of the faucet underbody 400 with the female threads inside the spout 454 and handles 450, the attachment of the stems of the valve cartridges to the handles 450, and the mounting nuts 456. Accordingly, making the faucet underbody 400 out of plastic can eliminate the need for a structurally supportive escutcheon.

1. A faucet underbody comprising:
a one-piece manifold comprising:
a spout opening comprising a first side and a second side,
a first side valve on the first side of the spout opening and a second side valve on the second side of the spout opening, wherein the first and second side valves each comprise a valve housing, and
a bridge integrally connecting the first and second side valves on the first and second sides of the spout opening;
two valve cartridges, each comprising one or more O-rings, a stationary ceramic disc, a moveable ceramic disc, a stem, and a friction washer; and
two male-threaded cartridge nuts, wherein the male-threaded cartridge nuts are configured to engage with female-threaded surfaces of each of the valve housings of the first and second side valves to secure the valve cartridges within the first and second side valves.

2. The faucet underbody of claim 1, wherein the male-threaded cartridge nuts are made of plastic.

3. The faucet underbody of claim 1, wherein the one-piece manifold is made of one or more plastics comprising one or more of a polyamide, a polyester, a polycarbonate, an acrylonitrile-butadiene-styrene, a polysulfone (PSU), a polyethersulfone (PESU), a cyclic olefin copolymer (COC), a polyphenylenesulfone (PPSU), a polyether ether ketone (PEEK), a polyethylenimine (PEI), a polyphthalamide (PPA), a polyacetal, copolymers thereof, or blends thereof.

4. The faucet underbody of claim 3, wherein the one or more plastics comprise Grivory HT1V-5 FWA natural.

5. The faucet underbody of claim 1, wherein the male-threaded cartridge nuts and the female-threaded surfaces have a thread size of at least one of M22 by 1.5 or 13/16-16UN-3B.

6. The faucet underbody of claim 1, wherein each valve housing of the first and second side valves is configured to receive and directly interface with each valve cartridge.

7. The faucet underbody of claim 1, wherein each valve cartridge is configured to be fully assembled when received by each valve housing of the first and second side valves.

8. The faucet underbody of claim 1, wherein each valve cartridge is configured to be assembled within each valve housing by consecutively fitting together parts of each valve cartridge inside each valve housing of the first and second side valves.

9. The faucet underbody of claim 1, wherein each valve cartridge comprises two or more integrated handle stop ribs.

10. The faucet underbody of claim 9, wherein each valve housing comprises two or more handle stops spaced apart on a first side and a second side of a circular interior surface of each valve housing, wherein each valve housing is configured to receive each respective integrated handle stop rib between each respective handle stop.

11. The faucet underbody of claim 10, wherein each respective integrated handle stop rib is configured to engage with each respective handle stop upon rotation of the respective valve cartridge within the first or second side valve so as to restrict rotation of a respective faucet handle attached to the respective valve cartridge to a quarter turn.

12. The faucet underbody of claim 1, wherein the faucet underbody is configured to be installed underneath a centerset faucet or a widespread faucet.

13. A one-piece manifold comprising:
a spout opening comprising a first side and a second side;
a first side valve on the first side of the spout opening and a second side valve on the second side of the spout opening, wherein the first and second side valves each comprise a valve housing configured to receive and directly interface with a valve cartridge, and wherein each valve housing comprises a female-threaded surface configured to engage with a male-threaded cartridge nut to secure each valve cartridge in each valve housing; and
a bridge integrally connecting the first and second side valves on the first and second sides of the spout opening.

14. The one-piece manifold of claim 13, wherein the one-piece manifold is made of one or more plastics comprising one or more of a polyamide, a polyester, a polycarbonate, an acrylonitrile-butadiene-styrene, a polysulfone (PSU), a polyethersulfone (PESU), a cyclic olefin copolymer (COC), a polyphenylenesulfone (PPSU), a polyether ether ketone (PEEK), a polyethylenimine (PEI), a polyphthalamide (PPA), a polyacetal, copolymers thereof, or blends thereof.

15. The one-piece manifold of claim 14, wherein the one or more plastics comprise Grivory HT1V-5 FWA natural.

16. The one-piece manifold of claim 13, wherein the female-threaded surfaces have a thread size of at least one of M22 by 1.5 or 13/16-16UN-3B.

17. The one-piece manifold of claim 13, wherein each valve housing is configured to receive a fully-assembled valve cartridge.

18. The one-piece manifold of claim 13, wherein each valve housing is configured to receive one or more parts of a valve cartridge to be assembled within each valve housing.

19. The one-piece manifold of claim 13, wherein each valve housing comprises two or more handle stops spaced apart on a first side and a second side of a circular interior surface of each valve housing, wherein each valve housing is configured to receive each respective integrated handle stop rib between each respective handle stop.

20. The one-piece manifold of claim 19, wherein each respective integrated handle stop rib is configured to engage with each respective handle stop upon rotation of the respective valve cartridge within the first or second side valve so as to restrict rotation of a respective faucet handle attached to the respective valve cartridge to a quarter turn.
